(19) United States
(12) Patent Application Publication
(10) Pub. No.: US 2005/0240949 A1
(43) Pub. Date: Oct. 27, 2005

(54) Optical recording/reproducing apparatus with dust resistant vents

(75) Inventors: Jin-Feng Liu, Shenzhen (CN); Jun-Feng Mu, Shenzhen (CN); Xi-Ping Dai, Shenzhen (CN)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(73) Assignee: HON HAI Precision Industry CO., LTD., Tu-Cheng City (TW)

(21) Appl. No.: 10/955,853

(22) Filed: Sep. 30, 2004

(30) Foreign Application Priority Data
Apr. 23, 2004 (CN) 200420045290.3

(51) Int. Cl. G11B 33/14

(52) U.S. Cl. 720/649

(57) ABSTRACT

An optical recording/reproducing apparatus includes an upper cover, a lower cover, and several vents. Each vent is arranged on the lower cover, and includes a first grille and a parallel second grille. The first and second grilles each include parallel louvers interleaved by parallel gaps. The first grille is arranged at an outer surface of the lower cover, while the second grille is arranged on an inner surface of the lower cover, with a clearance h separating the first and second grilles. Heat produced in the optical recording/reproducing apparatus is expelled out from the housing via the gaps of the second grille and the gaps of the first grille. However, external dust or contaminants that may enter the gaps of the first grille are blocked from entering the housing by the louvers of the second grille.

### BACKGROUND OF THE INVENTION

1. Field of the Invention

The present invention relates to optical recording/reproducing apparatuses, and particularly to an optical recording/reproducing apparatus with both heat dissipating and dust proofing characteristics.

2. Description of the Related Art

Optical recording/reproducing apparatuses are widely used in applications such as personal computers and entertainment equipment The writing/reading speed of optical recording/reproducing apparatuses has become faster and faster. Correspondingly, the basic requirements of the operating environment of optical recording/reproducing apparatuses have become more and more rigorous. For example, effective heat dissipation and dust prevention are gradually becoming more and more important, even to the point where they have become accepted criteria in judging the quality of an optical recording/reproducing apparatus.

A high speed optical recording/reproducing apparatus produces a large amount of heat. The heat can adversely affect various electronic components surrounding the heat-generating electronic components of a printed circuit board. This may lead to malfunction or even burnout of the components. Buildup of dust or other contaminants also adversely affects the optical recording/reproducing apparatus. Firstly, when dust accumulates on a pickup unit of the optical recording/producing apparatus, the intensity of laser beams transmitted from the pickup unit is reduced, and the quality of recording and reproducing is diminished Secondly, when dust accumulates on a disc, it can lead to incorrect focusing and tracking by the pickup unit Thirdly, the accumulation of dust on the components thermally insulates them, and reduces their ability to dissipate heat to ambient air Therefore, it is necessary to provide an optical recording/reproducing apparatus with both heat dissipating and dust proofing characteristics.

Some conventional optical recording/reproducing apparatuses are cooled down by means of an air-cooling fan. Heat within the optical recording/reproducing apparatus is taken away by air convection generated by the fan.

The fan can efficiently dissipate heat from the optical recording/reproducing apparatus. However, the fan is an added expense which takes up extra space. It is difficult to employ the fan in a miniaturized optical recording/reproducing apparatus. Moreover, the operation of the fan causes vibration and noise. The vibration may adversely affect the stability of the optical recording/reproducing apparatus.

Most if not all optical recording/reproducing apparatuses have openings in the housing thereof to allow ambient air to ventilate and cool down internal components. The efficacy of the openings is directly proportional to their number and size. However, when the number and size of the openings is increased, dust and other contaminants can enter the optical recording/reproducing apparatuses more easily

### SUMMARY OF THE INVENTION

Accordingly, an object of the present invention is to provide a simple and compact optical recording/reproducing apparatus with excellent heat dissipating and dust proofing characteristics.

In order to achieve the object set out above, an optical recording/reproducing apparatus of the present invention comprises an upper cover, a lower cover, a traverse module, a printed circuit board, and at least one vent The traverse module and the printed circuit board are received in a housing formed by the upper cover and the lower cover. The vent is arranged on the lower cover of the optical recording/reproducing apparatus, and comprises a first grille and a parallel second grille. The first and second grilles each comprise a plurality of parallel louvers interleaved by a plurality of parallel gaps. The first grille is arranged at an outer surface of the lower cover, while the second grille is arranged on an inner surface of the lower cover, with a clearance h separating the first and second grilles. Heat produced in the optical recording/reproducing apparatus is expelled out from the housing via the gaps of the second grille and the gaps of the first grille. However, external dust or contaminants that may enter the gaps of the first grille are blocked from entering the housing by the louvers of the second grille.

### BRIEF DESCRIPTION OF THE DRAWINGS

Other objects, advantages and novel features of the present invention will become more apparent from the following detailed description when taken in conjunction with the accompanying drawings, in which:

FIG. 1 is an exploded, isometric view of an optical recording/reproducing apparatus in accordance with the present invention;

FIG. 2 is an enlarged view of an upper cover of the optical recording/reproducing apparatus of FIG 1;

FIG. 3 is a top plan view of the upper cover of FIG. 2; and

FIG. 4 is a cross-sectional view taken along line IV-IV of FIG. 3.

### DETAILED DESCRIPTION OF THE INVENTION

Reference will now be made to the drawing figures to describe the preferred embodiment of the present invention in detail.

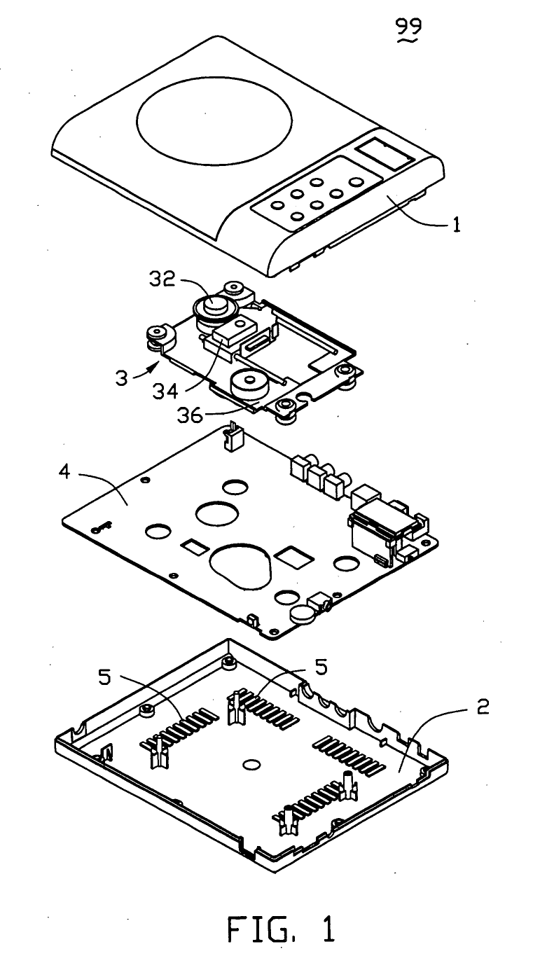

As shown in FIG. 1, an optical recording/reproducing apparatus 99 in accordance with the present invention includes an upper cover 1, a lower cover 2, a traverse module 3, a printed circuit board 4, and several air vents 5. The traverse module 3 and the printed circuit board 4 are dust-sensitive and received in a housing cooperatively formed by the upper cover 1 and the lower cover 2.

The traverse module 3 comprises a spindle motor 32, an optical pickup unit 34, and a base 36. The spindle motor 32 is adapted to rotate a disc (not shown). The optical pickup unit 34 moves along the radial direction of the disc, and is adapted to read information from or record information onto the disc. The base 36 supports the spindle motor 32 and the optical pickup unit 34 thereon.

The printed circuit board 4 controls the operation of the spindle motor 32 and the optical pickup unit 34 to make them cooperate with each other, and processes information read from or recorded into the disc by the optical pickup unit 34.

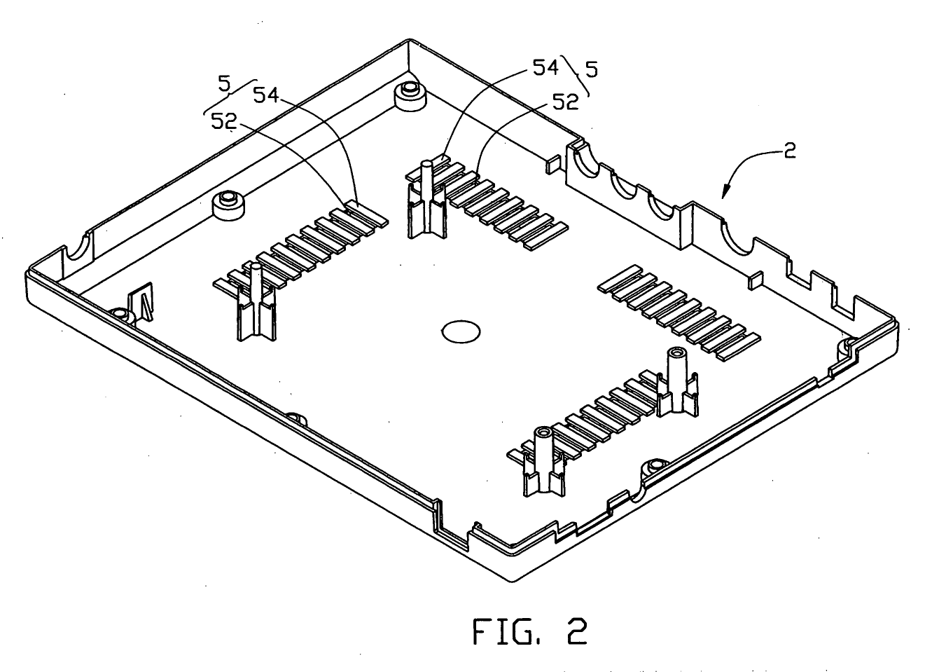

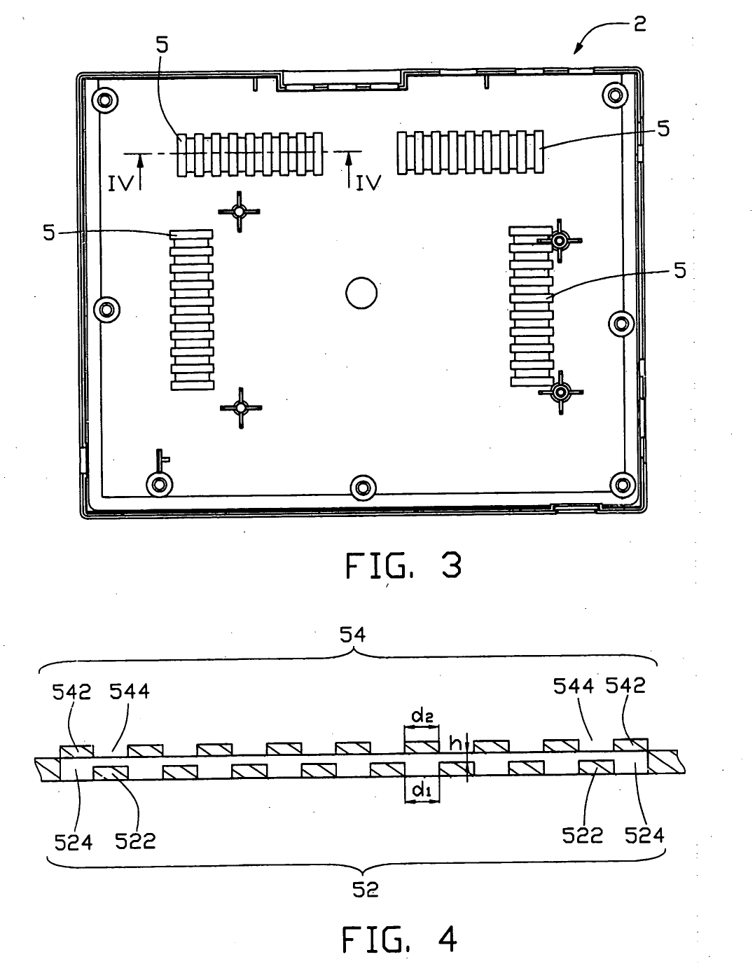

Referring to FIGS. 2, 3 and 4, several vents 5 are set on the lower cover 2 below heat-generating electronic components of the printed circuit board 4, to dissipate heat produced by the electronic components. Each vent 5 comprises a first grille 52 formed on a first surface level of the lower cover 2, and a second grille 54 formed on a second surface level of the lower cover 2. The first grille 52 is formed at an outer surface of the lower cover 2, while the second grille 54 is formed on an inner surface of the lower cover 2, with a clearance h separating the first and second grilles 52, 54. The first grille 52 comprises a plurality of parallel first louvers 522 interleaved by a plurality of parallel first gaps 524. Similarly, the second grille 54 comprises a plurality of parallel second louvers 542 interleaved by a plurality of parallel second gaps 544. The first louvers 522 and the second louvers 542 are parallel to each other, and are all bar-shaped. The first gaps 524 are opposite to the second louvers 542 respectively. A width d1 of each first gap 524 is equal to or less than a width d2 of each second louver 542.

Heat produced in the optical recording/reproducing apparatus 99 is expelled out from the housing via the second gaps 544 of the second grille 54 and the first gaps 524 of the first grille 52. However, external dust or contaminants that may enter the first gaps 524 are blocked from entering the housing by the second louvers 542 of the second grille 54. Thus, the internal heat is expelled out efficiently, whereas the external dust or contaminants are excluded efficiently.

In order to reduce the number of fabrication processes and lower manufacturing costs, the vents 5 can be integrally formed with the lower cover 2 by injection molding.

In alternative embodiments, based on different structures that the optical recording/reproducing apparatus 99 may have, the vents 5 can be provided at different positions of the lower cover 2, such as at side walls of the cover 2. Further or alternatively, the vents 5 can be provided at the upper cover 1. Depending on the different heat dissipating requirements that the optical recording/reproducing apparatus 99 may have, the number of vents 5 can be varies accordingly Further, the first and second louvers and gaps 522, 524, 542, 544 can have suitable alternative configurations other than being bar-shaped.

Although the present invention has been described with reference to specific embodiments, it should be noted that the described embodiments are not necessarily exclusive, and that various changes and modifications may be made to the described embodiments without departing from the scope of the invention as defined by the appended claims.

1. An optical recording/reproducing apparatus, comprising:
an upper cover,
a lower cover,
a traverse module;
a printed circuit board; and
at least one air vent located on at least one of the covers, comprising a fist grille arranged at an inner surface of the cover and a second grille arranged at an outer surface of the cover,
wherein the traverse module and the printed circuit board are accommodated in a housing cooperatively defined by the upper cover and the lower cover, the first and second grilles are parallel to each other, and the second grille is configured to block entry into the housing of foreign matter that is not blocked by the first grille.

2. The optical recording/reproducing apparatus as recited in claim 1, wherein the first grille comprises a plurality of first louvers and a plurality of first gaps interleaved by the first louvers, and the second grille comprises a plurality of second louvers and a plurality of second gaps interleaved by the second louvers.

3. The optical recording/reproducing apparatus as recited in claim 2, wherein the first and second louvers are both bar-shaped

4. The optical recording/reproducing apparatus as recited in claim 3, wherein a clearance separates the first and second grilles.

5. The optical recording/reproducing apparatus as recited in claim 4, wherein each first louver is parallel to each second louver.

6. The optical recording/reproducing apparatus as recited in claim 5, wherein the first gaps are opposite to the second louvers respectively

7. The optical recording/reproducing apparatus as recited in claim 6, wherein widths of the first gaps are equals to corresponding widths of the second louvers.

8. The optical recording/reproducing apparatus as recited in claim 6, wherein widths of the first gaps are less than corresponding widths of the second louvers.

9. The optical recording/reproducing apparatus as recited in claim 1, wherein said vent is mounted on the lower cover under heat-generating electronic components of the printed circuit board

10. The optical recording/reproducing apparatus as recited in claim 1, wherein said vent is integrally formed with the cover.

11. The optical recording/reproducing apparatus as recited in claim 10, wherein said vent is formed by injection molding.

12. An optical recording/reproducing apparatus, comprising:
a traverse module;
a printed circuit board;
at least one cover, and
at least one outlet means for heat dissipation and dust prevention, being located on the at least one cover, and comprising a first passage means arranged at an inner surface of the at least one cover and a second passage means arranged at an outer surface of the at least one cover,
wherein the traverse module and the printed circuit board are accommodated in the at least one cover, and the first and second passage means are parallel to each other and separated by a clearance.

13. The optical recording/reproducing apparatus as recited in claim 12, wherein the first passage means comprises a plurality of first louvers and a plurality of first gaps interleaving the first louvers, and the second passage means comprises a plurality of second louvers and a plurality of second gaps interleaving the second louvers.

14. The optical recording/reproducing apparatus as recited in claim 13, wherein the first and second louvers are all bar-shaped

15. The optical recording/reproducing apparatus as recited in claim 14, wherein each first louver is parallel to each second louver.

16. The optical recording/reproducing apparatus as recited in claim 15, wherein the first gaps are opposite to the second louvers respectively.

17. The optical recording/reproducing apparatus as recited in claim 16, wherein widths of the first gaps are less than or equal to corresponding widths of the second louvers.

18. An optical recording/reproducing apparatus, comprising:
a housing having a dust-sensitive component installed therein;
a plurality of gaps formed on a first surface level of said housing to allow air circulating therethrough into and out of said housing, a louver formed on a second surface level of said housing and aligning with each of said plurality of said gaps, said louver being larger than said aligned gaps thereof.

19. The optical recording/reproducing apparatus as recited in claim 18, wherein said first surface level of said housing is located outer Man said second sure level of said housing.

20. The optical recording/reproducing apparatus as recited in claim 18, wherein another gap is formed on said second surface level between every two neighboring louvers.
